(19) United States
(12) Patent Application Publication
(10) Pub. No.: US 2021/0327618 A1
(43) Pub. Date: Oct. 21, 2021

(54) MAGNETIC NANO-STRUCTURE CONTAINING IRON AND METHOD FOR MANUFACTURING SAME

(71) Applicant: INDUSTRY-UNIVERSITY COOPERATION FOUNDATION HANYANG UNIVERSITY ERICA CAMPUS, Ansan-Si, Gyeonggi-do (KR)

(72) Inventors: Yong-Ho Choa, Seongnam-si (KR); Jongryoul Kim, Seoul (KR); Jimim Lee, Seoul (KR); Tae-Yeon Hwang, Ansan-si (KR); Min Kyu Kang, Daegu (KR); Gyutae Lee, Seoul (KR)

(73) Assignee: INDUSTRY-UNIVERSITY COOPERATION FOUNDATION HANYANG UNIVERSITY ERICA CAMPUS, Ansan-Si, Gyeonggi-do (KR)

(21) Appl. No.: 17/260,603

(22) PCT Filed: Jan. 31, 2019
(86) PCT No.: PCT/KR2019/001365

§ 371 Date: Jan. 15, 2021

(30) Foreign Application Priority Data
Nov. 28, 2018 (KR) 10-2018-0149437
Jan. 30, 2019 (KR) 10-2019-0011807

(51) Int. Cl. H01F 1/055; C22C 19/07; C22C 30/00

(52) U.S. Cl. CPC H01F 1/055; C22C 2202/02; C22C 30/00; C22C 19/07

(57) ABSTRACT

Provided is a method for manufacturing a magnetic nano-structure. The method for manufacturing a magnetic nano-structure may comprise the steps of: preparing a source solution containing a first precursor including a rare-earth element, a second precursor including a transition metal element, and a third precursor including Fe; electrospinning the source solution to form a preliminary magnetic nano-structure containing a rare-earth oxide, a transition metal oxide, and a Fe oxide; and reducing the preliminary magnetic micro-structure to manufacture a magnetic nano-structure containing an alloy composition of the rare-earth element, the transition metal element, and the Fe.

### TECHNICAL FIELD

The present invention relates to a magnetic nano-structure containing iron and a method for manufacturing the same, and more particularly, to a magnetic nano-structure containing iron and a method for manufacturing the same by using a process of spinning a source solution containing a rare-earth element.

### BACKGROUND ART

Hard magnetic permanent magnets have been used indispensably for electric devices such as motors, speakers, and measuring instruments, as well as small motors in hybrid vehicles (HEVs) and electric vehicles (EVs). R2Fe14B series, R2Fe17Nx series and R2TM17 series (R: rare-earth element, TM: transition metal element) having high a coercive force are widely used as a material for the above magnets. Unlike the former two series, the R2TM17 series has an advantage in an aspect of phase formation and chemical stability because the R2TM17 series is not easily pyrolyzed and has a high Curie temperature.

Recently, as electronic products have a lighter weight, miniaturized size and higher performance, a permanent magnet material having a more improved maximum magnetic energy product ((BH)max) is required. However, because each material has a critical point of magnetic properties, researches for overcoming the critical point have been conducted.

For example, Korean Unexamined Patent Publication No. 10-2017-0108468 (Application No. 10-2016-0032417. Applicant: Yonsei University Industry-Academic Cooperation Foundation) discloses a non-rare-earth permanent magnet having an improved coercive force and including a substrate; and a thin film laminate formed on the substrate and obtained by repeatedly laminating and heat-treating a lamination unit, which is composed of a Bi thin film layer and an Mn thin film layer, at least two times or more, and a method for manufacturing the same.

### DISCLOSURE

### Technical Problem

One technical problem to be solved by the present invention is to provide a magnetic nano-structure containing iron (Fe) and a method for manufacturing the same to have improved magnetic properties.

Another technical problem to be solved by the present invention is to provide a magnetic nano-structure containing iron (Fe) and a method for manufacturing the same to improve magnetic properties through a simple process.

Still another technical problem to be solved by the present invention is to provide a magnetic nano-structure containing iron (Fe) and a method for manufacturing the same to reduce economic costs.

The technical problems to be solved by the present invention are not limited to the above descriptions.

### Technical Solution

In order to solve the above-mentioned technical problems, the present invention provides a method for manufacturing a magnetic nano-structure.

According to one embodiment, the method for manufacturing the magnetic nano-structure includes: preparing a source solution containing a first precursor including a rare-earth element, a second precursor including a transition metal element, and a third precursor including Fe; electrospinning the source solution to form a preliminary magnetic nano-structure containing a rare-earth oxide, a transition metal oxide, and a Fe oxide; and reducing the preliminary magnetic micro-structure to manufacture a magnetic nano-structure containing an alloy composition of the rare-earth element, the transition metal element, and the Fe, and may include controlling a maximum magnetic energy product value ((BH)max) by controlling a content of Fe.

According to one embodiment, the weight ratio of Fe in the source solution may be more than 3.7 wt % and less than 14.7 wt %.

According to one embodiment, the step of forming the magnetic nano-structure may include mixing the preliminary magnetic nano-structure with a reducing agent, heat-treating the preliminary magnetic nano-structure mixed with the reducing agent, and washing the heat-treated preliminary magnetic nano-structure by using a cleaning solution.

According to one embodiment, the reducing agent may include calcium (Ca).

According to one embodiment, the method for manufacturing the magnetic nano-structure may include controlling a maximum magnetic energy product value ((BH)ₘₐₓ) by controlling a content of Fe.

In order to solve the above-mentioned technical problems, the present invention provides a magnetic nano-structure.

According to one embodiment, the magnetic nano-structure includes an alloy composition of a rare-earth element, a transition metal element, and Fe, and the content of Fe in the alloy composition may be more than 3.7 wt % and less than 14.7 wt %.

According to one embodiment, the alloy composition may be composed of a unit lattice (unit cell) represented by Re₂M₁₇ (Re is a rare-earth element, and M is at least one of a transition metal element or Fe).

According to one embodiment, a crystal structure of the Re₂M₁₇ may be any one of a hexagonal system or a rhombohedral system.

According to one embodiment, Fe may be disposed in at least one of 4f, 6g, 12j, and 12k sites in the unit lattice.

According to one embodiment, the rare-earth element may include any one of La, Ce, Pr, Nd, Sm, or Gd.

According to one embodiment, the transition metal element may include any one of Co or Ni.

According to one embodiment, the magnetic nano-structure may have a single crystal and an anisotropic property.

According to one embodiment, in the alloy composition, the content of the rare-earth element may be more than 23.1 wt % and less than 23.3 wt %, and the content of the transition metal element may be more than 62.0 wt % and less than 73.2 wt %.

According to another embodiment, the magnetic nano-structure may include an alloy composition composed of a unit lattice represented by following <Formula 1>.

Re₂TMₓFe₁₇₋ₓ <Formula 1>

(Re: rare-earth element, TM: transition metal element)

According to another embodiment, the magnetic nano-structure may include an alloy composition having a unit lattice represented by the above <Formula 1> after more than 5% and less than 20% of the TM is substituted with the Fe in the alloy composition composed of a unit lattice represented by the following <Formula 2>.

Re₂TM₁₇ <Formula 2>

(Re: rare-earth element, TM: transition metal element)

According to another embodiment, the magnetic nano-structure may have a coercive force of 7000 Oe or more.

The method for manufacturing a magnetic nano-structure according to the embodiments of the present invention includes: preparing a source solution containing a first precursor including a rare-earth element, a second precursor including a transition metal element, and a third precursor including Fe; electrospinning the source solution to form a preliminary magnetic nano-structure containing a rare-earth oxide, a transition metal oxide, and a Fe oxide; and reducing the preliminary magnetic micro-structure to manufacture a magnetic nano-structure containing an alloy composition of the rare-earth element, the transition metal element, and the Fe.

### Advantageous Effects

The method for manufacturing a magnetic nano-structure according to the embodiment may have a bottom-up approaching properties.

When a magnetic nano-structure is manufactured through the manufacturing method with the above bottom-up approaching properties, the Fe content in the magnetic nano-structure, which is the finally generated material, can be controlled by a simple method of controlling the content of the third precursor in the step of preparing the source solution. As described above, when the Fe content in the magnetic nano-structure is controlled to be greater than 3.7 wt % and less than 14.7 wt %, or when more than 5% and less than 20% of the TM is substituted with the Fe in the alloy composition composed of a unit lattice represented by the above <Formula 2> so as to have a unit lattice represented by the above <Formula 1>, the maximum magnetic energy product value of the magnetic nano-structure can be improved. As a result, the magnetic nano-structure having improved magnetic properties can be provided. In addition, iron is used instead of expensive cobalt, so that the magnetic nano-structure reduced in economic costs can be provided.

### DESCRIPTION OF DRAWINGS

FIG. 1 is a flow chart illustrating a method for manufacturing a magnetic nano-structure according to the embodiment of the present invention.

FIG. 2 is a flow chart specifically illustrating a step of forming a magnetic nano-structure in the method for manufacturing the magnetic nano-structure according to the embodiment of the present invention.

FIG. 3 is a view showing a manufacturing process of the magnetic nano-structure according to the embodiment of the present invention.

FIG. 4 is a view showing a unit lattice represented by Sm₂Co₁₇ to illustrate a structure of the magnetic nano-structure according to the embodiment of the present invention.

FIGS. 5 and 6 are XRD analysis graphs for analyzing structures of magnetic nano-structures according to the Examples and Comparative Example of the present invention.

FIG. 7 is a graph for comparing saturation magnetizations of the magnetic nano-structures according to the Examples and Comparative Example of the present invention.

FIG. 8 is a graph for comparing remanence magnetizations of the magnetic nano-structures according to the Examples and Comparative Example of the present invention.

FIG. 9 is a graph for comparing rectangularity ratios of the magnetic nano-structures according to the Examples and Comparative Example of the present invention.

FIG. 10 is a graph for comparing coercive forces of the magnetic nano-structures according to the Examples and Comparative Example of the present invention.

FIG. 11 is a graph for comparing maximum magnetic energy products of the magnetic nano-structures according to the Examples and Comparative Example of the present invention.

### BEST MODE

### Mode for Invention

Hereinafter, exemplary embodiments of the present invention will be described in detail with reference to the accompanying drawings. However, the technical idea of the present invention is not limited to the exemplary embodiments described herein and may be embodied in other forms. Further, the embodiments disclosed thoroughly and completely herein may be provided such that the idea of the present invention can be fully understood by those skilled in the art.

In the specification, when one component is mentioned as being on another component, it signifies that the one component may be placed directly on another component or a third component may be interposed therebetween. In addition, in drawings, thicknesses of films and regions may be exaggerated to effectively describe the technology of the present invention.

In addition, although the terms such as first, second and third are used to describe various components in various embodiments of the present specification, the components should not be limited by the above terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it should be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, in the following description of the embodiments of the present invention, the detailed description of known functions and configurations incorporated herein will be omitted when it possibly makes the subject matter of the present invention unclear unnecessarily.

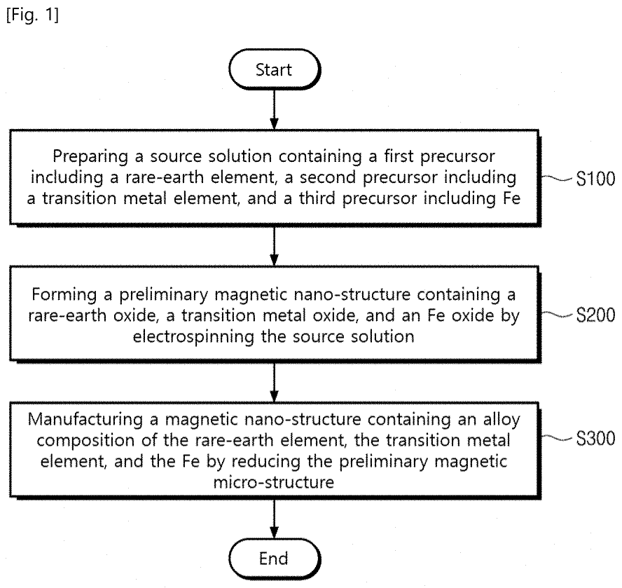

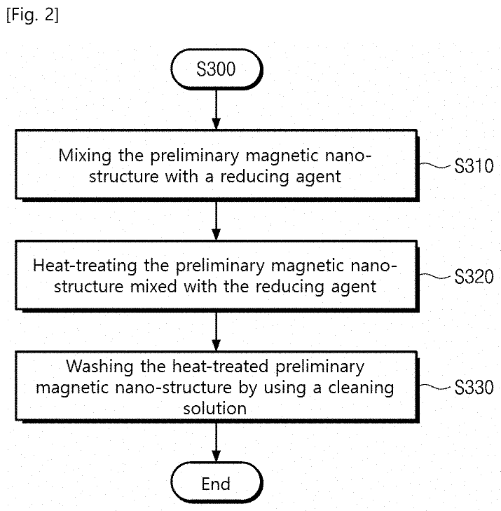

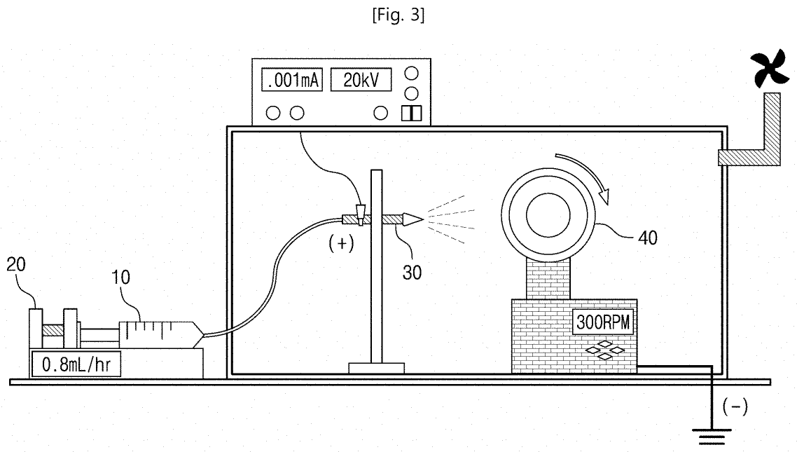

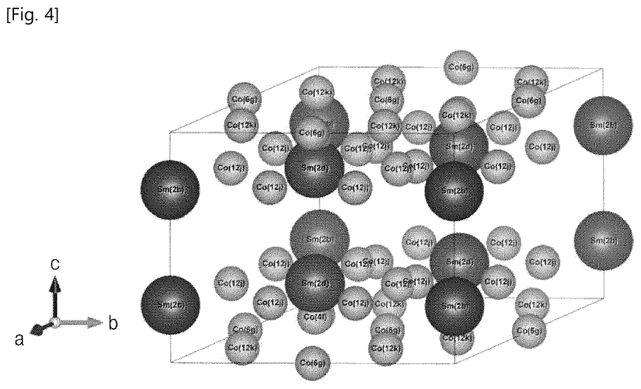

FIG. 1 is a flow chart illustrating a method for manufacturing a magnetic nano-structure according to the embodiment of the present invention. FIG. 2 is a flow chart specifically illustrating a step of forming a magnetic nano-structure in the method for manufacturing the magnetic nano-structure according to the embodiment of the present invention. FIG. 3 is a view showing a manufacturing process of the magnetic nano-structure according to the embodiment of the present invention. FIG. 4 is a view showing a unit lattice represented by Sm₂Co₁₇ to illustrate a structure of the magnetic nano-structure according to the embodiment of the present invention.

Referring to FIGS. 1 to 3, a source solution including a first precursor, a second precursor, and a third precursor may be prepared (S100). According to one embodiment, the first precursor may include a rare-earth element. For example, the rare-earth element may include any one of La, Ce, Pr, Nd, Sm, or Gd. According to one embodiment, the second precursor may include a transition metal element. For example, the transition metal element may include any one of Co or Ni. According to one embodiment, the third precursor may include Fe.

The source solution may further include a viscous source. According to one embodiment, the viscous source may include polymer. For example, the polymer may include at least one of polyvinylpyrrolidone (PVP), polyacrylonitrile (PAN), polyvinyl acetate (PVAC), polyvinylbutyral (PVB), polyvinyl alcohol (PVA), or polyethylene oxide (PEO). The viscous source may provide viscosity to the source solution, so that a diameter of the magnetic nano-structure described later may be controlled.

According to one embodiment, a molar fraction (at %) of the third precursor in the source solution may be controlled. Specifically, the weight ratio of Fe in the source solution may be controlled to be greater than 3.7 wt % and less than 14.7 wt %. In this case, the magnetic nano-structure described later may have a unit lattice represented by the above <Formula 1> after more than 5% and less than 20% of the TM is substituted with the Fe in the alloy composition composed of a unit lattice represented by the following <Formula 2>. Accordingly, the maximum magnetic energy product value ((BH)ₘₐₓ) of the magnetic nano-structure may be improved. More details will be described later.

Re₂TMₓFe₁₇₋ₓ <Formula 1>

(Re: rare-earth element, TM: transition metal element)

Re₂TM₁₇ <Formula 2>

(Re: rare-earth element, TM: transition metal element)

The source solution may be electrospun to form a preliminary magnetic nano-structure (S200). The preliminary magnetic nano-structure formed by electrospinning the source solution may include rare-earth oxide, transition metal oxide, and Fe oxide.

According to one embodiment, the step of forming the preliminary hybrid magnetic fiber may include forming a first preliminary hybrid magnetic fiber, and forming a second preliminary hybrid magnetic fiber. The step of forming the first preliminary hybrid magnetic fiber may be performed by electrospinning the source solution. The first preliminary hybrid magnetic fiber may be formed of solid components of the source solution. The first preliminary hybrid magnetic fiber may include water-soluble metallic salt, polymer, and the like. The step of forming the second preliminary hybrid magnetic fiber may be performed by calcining the first preliminary hybrid magnetic fiber. In other words, the step may be performed by heat-treating the first preliminary hybrid magnetic fiber and decomposing organic materials including polymer in the first preliminary hybrid magnetic fiber. The second preliminary hybrid magnetic fiber may include rare-earth oxide, transition metal oxide, and Fe oxide.

More specifically, after the source solution is injected into a syringe 10, the source solution may be spun using a syringe pump 20. In this case, a tip 30 of the syringe may have a diameter of 0.05 mm to 2 mm, the syringe tip 30 and a collector 40 for collecting the preliminary hybrid magnetic fiber may be spaced apart from each other by 10 cm to 20 cm, and the syringe pump 20 may spin the source solution at a rate of 0.3 mL/h to 0.8 mL/h. In addition, a voltage applied for electrospinning may be 16 kV to 23 kV. The first preliminary hybrid magnetic fiber may be formed through the above-described process.

The first preliminary hybrid magnetic fiber may be collected in an alumina crucible and heat-treated at an atmospheric pressure, that is, an atmospheric atmosphere of 500° C. to 900° C. In the above process, the organic materials including polymer may be entirely pyrolyzed. A heating rate condition may be 1° C. to 10° C. per minute. The second preliminary hybrid magnetic fiber may be formed through the above-described process.

The preliminary magnetic nano-structure may be reduced to form a magnetic nano-structure (S300). The magnetic nano-structure may include an alloy composition of a rare-earth element, a transition metal element, and Fe. In addition, the magnetic nano-structure may be an alloy composition composed of a unit lattice represented by following <Formula 1>. More specifically, the magnetic nano-structure may include 21 wt % to 30 wt % of the rare-earth element, 62 wt % to 73 wt % of the transition metal element, and 5 wt % to 11 wt % of the Fe. In addition, because being formed by the electrospinning as described above, the magnetic nano-structure may have a wire shape or a fiber shape.

Re₂TMₓFe₁₇₋ₓ <Formula 1>

(Re: rare-earth element, TM: transition metal element)

According to one embodiment, the magnetic nano-structure may have a crystal structure. For example, the magnetic nano-structure may have a single crystal structure. When the magnetic nano-structure has a crystal structure, the magnetic nano-structure may be composed of a unit lattice (unit cell) represented by Re₂M₁₇ (Re is a rare-earth element, and M is at least one of a transition metal element or Fe). The crystal structure of Re₂M₁₇ may be a hexagonal system or a rhombohedral system.

The arrangement of atoms in the unit lattice represented by Re₂M₁₇ may be the same as the arrangement of atoms in the unit lattice represented by Sm₂Co₁₇. In other words, the arrangement of Re (rare-earth element) in the unit lattice represented by Re₂M₁₇ may be the same as the arrangement of Sm in the unit lattice represented by Sm₂Co₁₇. In addition, the arrangement of M (at least one of a transition metal element or Fe) in the unit lattice represented by Re₂M₁₇ may be the same as the arrangement of Co in a unit lattice represented by Sm₂Co₁₇.

For further specific description, FIG. 4 shows the unit lattice represented by Sm₂Co₁₇. As shown in FIG. 4, Co in the unit lattice represented by Sm₂Co₁₇ may be disposed in at least one of 4f, 6g, 12j, and 12k sites. Accordingly, M in the unit lattice represented by Re₂M₁₇ may also be disposed in at least one of 4f, 6g, 12j, and 12k sites. In other words, the transition metal element or Fe may be disposed in 4f, 6g, 12j, and 12k sites of the unit lattice represented by Re₂M₁₇.

As described above, because the magnetic nano-structure according to the embodiment has Fe, a saturation magnetization value, a remanant magnetization value, and a coercive force may be increased.

Specifically, a magnetic spin moment value of Fe is greater than a magnetic spin moment value of the transition metal element (for example, Co). Accordingly, compared to the magnetic nano-structure that does not include Fe, the magnetic nano-structure according to the embodiment may have increased saturation magnetization value and remanant magnetization value.

In addition, an atomic radius (1.72 Å) of Fe is greater than an atomic radius of the transition metal element (for example, 1.67 Å in the case of Co). Accordingly, a magnetocrystalline anisotropy of the magnetic nano-structures is improved, so that the coercive force may be improved. In other words, compared to the magnetic nano-structure that does not include Fe, the magnetic nano-structure according to the embodiment hay have an improved coercive force.

As the Fe content increases, the magnetic nano-structure according to the embodiment, a saturation magnetization value and a remanence magnetization value may be improved. However, when the Fe content exceeds a predetermined criterion, there may be a problem that the coercive force decreases. As a result, when the Fe content exceeds a predetermined criterion, there may be a problem that the maximum magnetic energy product value ((BH)ₘₐₓ) expressed by the product of the saturation magnetization value and the coercive force decreases. Accordingly, the Fe content in the magnetic nano-structure according to the embodiment may be controlled to obtain a high maximum magnetic energy product value.

According to one embodiment, the Fe content in the magnetic nano-structure may be controlled to be greater than 3.7 wt % and less than 14.7 wt %. In addition, the magnetic nano-structure may include an alloy composition having a unit lattice represented by the above <Formula 1> after more than 5% and less than 20% of the TM is substituted with the Fe in the alloy composition composed of a unit lattice represented by the following <Formula 2>.

Re₂TM₁₇ <Formula 2>

(Re: rare-earth element, TM: transition metal element)

In other words, when a substitution amount of Fe substituted with the TM is controlled to be greater than 5% and less than 20% in the magnetic nano-structure, Fe in the magnetic nano-structure may have a content greater than 3.7 wt % and less than 14.7 wt %. When the content of Fe is controlled in the above-described manner, the magnetic nano-structure may exhibit an Re₂M₁₇ single phase, and may exhibit a high coercive force of 7000 Oe or more and a high maximum magnetic energy product value of 13 MGOe or more. The Re₂M₁₇ single phase may exhibit an anisotropy so that a high coercive force may be exhibited. However, when a plurality of phases are mixed, an isotropy may be exhibited, so a low coercive force may be exhibited.

Unlike the above description, when the Fe content in the magnetic structure is 3.7 wt % or less, or the substitution amount of Fe is 5% or less, the saturation magnetization value of the magnetic nano-structure according to the embodiment decreases, and accordingly, there may be a problem that a relatively low maximum magnetic energy product value is exhibited. In addition, when the Fe content in the magnetic structure is 14.7 wt % or more, or the substitution amount of Fe is 20% or more, the magnetic nano-structure may exhibit a structure formed by mixing an Re₂M₇ phase, an Fe phase, and an Re₂M₁₇ phase, so that the coercive force may be deteriorated. Accordingly, there may be a problem that a relatively low maximum magnetic energy product value is exhibited.

According to one embodiment, the step of forming the magnetic nano-structure (S300) may include mixing the preliminary magnetic nano-structure with a reducing agent (S310), heat-treating the preliminary magnetic nano-structure mixed with the reducing agent (S320), and washing the heat-treated preliminary magnetic nano-structure by using a cleaning solution (S330). In other words, the preliminary magnetic nano-structure is mixed with the reducing agent and heat-treated, so that the magnetic nano-structure may be formed.

The reducing agent may include calcium (Ca). For example, the reducing agent may include CaH2. In this case, the magnetic nano-structure may be easily formed. Specifically, since the rare-earth elements have very little oxidation energy, the most stable phase may be maintained during an oxide form. Accordingly, since a high temperature of 1500° C. or higher and a hydrogen atmosphere are required to reduce the rare-earth oxide to metal, there may be difficulties in process. However, since calcium (Ca) has smaller oxidation energy compared to the rare-earth elements, the rare-earth oxide may be easily reduced to metal in a relatively low heat-treatment temperature (for example, 500° C. to 800° C.) and a non-hydrogen atmosphere when calcium is used as a reducing agent.

The washing solution may include at least one of ammonium chloride (NH4Cl) and methanol (CH3OH). In this case, the magnetic nano-structure may be easily formed. Specifically, when the preliminary magnetic nano-structure is reduced using a reducing agent containing calcium (Ca), calcium oxide (CaO) may be formed on a surface of metal from which the rare-earth oxide is reduced. Accordingly, a process of removing calcium oxide (CaO) is required. The existing process of removing calcium oxide (CaO) uses a washing solution in which acetic acid or hydrochloric acid is mixed with ultrapure water. In this case, the acid solution may cause a fatal effect such as corrosion and oxidation even on the magnetic phase. However, a washing solution containing at least one of ammonium chloride (NH4Cl) and methanol (CH3OH) may easily remove calcium oxide (CaO) without affecting the magnetic phase.

The conventional methods of manufacturing a rare-earth permanent magnet include powder metallurgy scheme such as melt casting, extrusion molding or injection molding of ingots, and those are characterized by a top-down approach. When a substitution type alloy is manufactured through the top-down approach, a complex microstructure of grain-grain boundary other than a single crystal shape may be easily formed, and an isotropic alloy may be obtained while generating numerous grains. The above isotropic alloy may consequently lower the coercive force, thereby causing deterioration of magnetic properties. In addition, since defects and impurities may be easily generated at the grain boundaries, and grains and grain boundaries may be easily formed in different phases, a behavior of a binary-phase separated on a magnetic hysteresis curve may be exhibited, and the magnetic properties may be adversely affected.

However, the method for manufacturing a magnetic nano-structure according to the embodiments of the present invention may include preparing a source solution containing a first precursor including a rare-earth element, a second precursor including a transition metal element, and a third precursor including Fe; electrospinning the source solution to form a preliminary magnetic nano-structure containing a rare-earth oxide, a transition metal oxide, and a Fe oxide; and reducing the preliminary magnetic micro-structure to manufacture a magnetic nano-structure containing an alloy composition of the rare-earth element, the transition metal element, and the Fe In other words, the method for manufacturing a magnetic nano-structure according to the embodiment may have a bottom-up approaching properties.

When the magnetic nano-structure is manufactured through the manufacturing method with the above bottom-up approaching properties, the Fe content in the magnetic nano-structure, which is the finally generated material, may be controlled by a simple method of controlling the content of the third precursor in the step of preparing the source solution. As described above, when the Fe content in the magnetic nano-structure is controlled to be greater than 3.7 wt % and less than 14.7 wt %, or when more than 5% and less than 20% of the TM is substituted with the Fe in the alloy composition composed of a unit lattice represented by the above <Formula 2> so as to have a unit lattice represented by the above <Formula 1>, the maximum magnetic energy product value of the magnetic nano-structure may be improved. As a result, the magnetic nano-structure having improved magnetic properties may be provided. In addition, iron is used instead of expensive cobalt, so that the magnetic nano-structure reduced in economic costs may be provided.

The magnetic nano-structure and the method for manufacturing the same according to the embodiments of the present invention have been described. Hereinafter, results on specific experimental examples and characteristic evaluations will be described with respect to the magnetic nano-structure and the method for manufacturing the same according to the embodiments of the present invention.

Manufacturing a Magnetic Nano-Structure According to Example 1

The source solution was prepared by mixing samarium (III) nitrate hexahydrate (Sm(NO₃)₃6H₂O), cobalt (II) nitrate hexahydrate (Co(NO₃)₂6H₂O), iron (III) nitrate nonahydrate (Fe(NO₃)₃9H₂O), and PVP having a concentration of 3 wt % with 10 mL of ultrapure water.

The prepared source solution was placed in a syringe for electrospinning, and the solution was continuously pushed at a speed of 0.8 mL/h using a syringe pump. A tip portion of the syringe and a collector for collecting spun fibers were separated from each other at 15 cm intervals, and a high voltage of 20 kV was applied to spin the source solution due to a potential difference. Materials deposited on the collector were collected in an alumina (Al₂O₃) crucible and calcined for 3 hours at a temperature of about 700° C. in an air atmosphere to decompose all organic substances including polymer.

The calcined material was mixed with CaH2 in the volume ratio of 1:1, reduced by heat-treating the mixture for 1 hour at a temperature of about 700° C. in an inert atmosphere, and washed with water using a mixed solution of ammonium chloride and methanol, so that a magnetic nano-structure according to Example 1, in which 5% of Fe was substituted in place of Co, was manufactured.

Manufacturing a Magnetic Nano-Structure According to Example 2

The magnetic nano-structure was manufactured according to Example 1, in which the ratio of iron (III) nitrate nonahydrate (Fe(NO₃)₃9H₂O) in the source solution was controlled, so that a magnetic nano-structure according to Example 2, in which 10% of Fe was substituted in place of Co, was manufactured.

Manufacturing a Magnetic Nano-Structure According to Example 3

The magnetic nano-structure was manufactured according to Example 1, in which the ratio of iron (III) nitrate nonahydrate (Fe(NO₃)₃9H₂O) in the source solution was controlled, so that 20% of Fe was substituted in place of Co. Thus, a magnetic nano-structure according to Example 3 was manufactured.

Manufacturing a Magnetic Nano-Structure According to Example 4

The magnetic nano-structure was manufactured according to Example 1, in which the ratio of iron (III) nitrate nonahydrate (Fe(NO₃)₃9H₂O) in the source solution was controlled, so that 40% of Fe was substituted in place of Co. Thus, a magnetic nano-structure according to Example 4 was manufactured.

Manufacturing a Magnetic Nano-Structure According to Comparative Example

The source solution was prepared by mixing samarium (III) nitrate hexahydrate (Sm(NO₃)₃6H₂O), cobalt (II) nitrate hexahydrate (Co(NO₃)₂6H₂O), and PVP with ultrapure water.

The prepared source solution was spun and reduced by the method according to Example 1, so that a magnetic nano-structure without including Fe according to Comparative Example was manufactured.

The magnetic nano-structures according to the Examples and Comparative Example will be summarized in the following <Table 1>, and the specific component rates of the magnetic nano-structures according to the Examples and Comparative Example will be summarized in the following <Table 2>.

TABLE 1

| | | Fe |
|---|---|---|
| | | substitution |
| | | amount |
| | | in place |
| Item | Configuration | of Co |
| Example 1 | Sm—Co—Fe | 5% |
| Example 2 | Sm—Co—Fe | 10% |
| Example 3 | Sm—Co—Fe | 20% |
| Example 4 | Sm—Co—Fe | 40% |
| Comparative | Sm—Co | 0% |
| Example | | |

TABLE 2

| Item | Sm | Co | Fe |
|---|---|---|---|
| Example 1 | 23.1 wt % | 73.2 wt % | 3.7 wt % |
| Example 2 | 23.2 wt % | 69.5 wt % | 7.3 wt % |
| Example 3 | 23.3 wt % | 62.0 wt % | 14.7 wt % |
| Example 4 | 23.5 wt % | 46.9 wt % | 29.6 wt % |
| Comparative | 23.1 wt % | 76.9 wt % | 0 wt % |
| Example | | | |

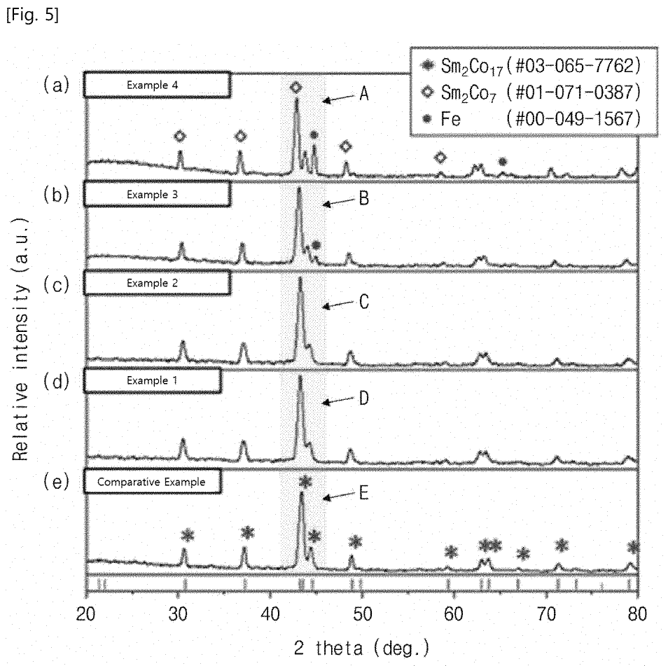

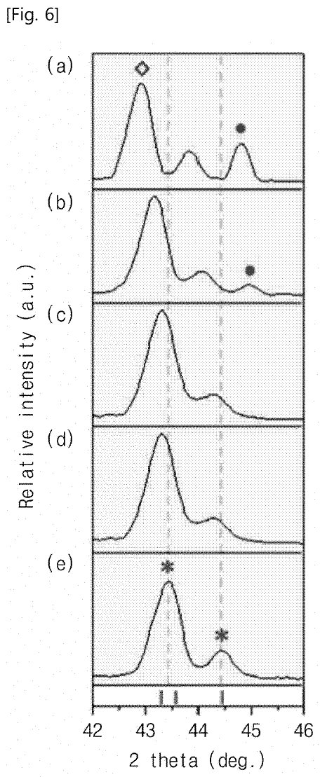

FIGS. 5 and 6 are XRD analysis graphs for analyzing structures of magnetic nano-structures according to the Examples and Comparative Example of the present invention.

Referring to FIGS. 5 and 6, results of X-ray diffraction analysis are shown by measuring relative intensity (a.u.) according to 2theta (deg.) for each of the magnetic nano-structures according to Examples 1 to 4 and the magnetic nano-structure according to the Comparative Example. FIGS. 5(a) to 5(e) show the results of X-ray diffraction analysis of magnetic nano-structures according to Example 4, Example 3, Example 2, Example 1, and Comparative Example, respectively, and FIGS. 6(a) to 6(e) are graphs showing enlarged portions A to E indicated in FIGS. 5(a) to 5(e).

As shown in FIGS. 5(c) to 5(e) and FIGS. 6(c) to 6(e), it is confirmed that a diffraction pattern is shifted to a low angle in the magnetic nano-structures according to Examples 1 and 2, compared with the magnetic nano-structure according to the Comparative Example showing an Sm₂Co₁₇ single phase. It can be determined that this is because a lattice shrinkage occurs as Fe is disposed at 4f, 6g, 12j, and 12k sites in the unit lattice.

In other words, the magnetic nano-structures according to Examples 1 and 2 may include a unit lattice represented by Re₂M₁₇ as described above, and the arrangement of atoms in the unit lattice represented by Re₂M₁₇ may be the same as the arrangement of atoms in the unit lattice represented by Sm₂Co₁₇. However, in the alloy composition composed of a unit lattice represented by Re₂M₁₇, Co and Fe having different atomic radii are arranged at 4f, 6g, 12j, and 12k sites in the unit lattice, so that lattice shrinkage may occur, which may lead to a change in lattice constant, thereby causing a shift in the diffraction pattern.

As a result, the diffraction pattern graphs shown in FIGS. 5(c) and 5(d) and 6(c) and 6(d) may signify that the magnetic nano-structures according to Examples 1 and 2 are composed of a unit lattice represented by Re₂M₁₇, and the arrangement of atoms in the unit lattice represented by Re₂M₁₇ is the same as the arrangement of atoms in the unit lattice represented by Sm₂Co₁₇, in which Fe is disposed at any one of the 4f, 6g, 12j, and 12k sites in the unit lattice.

In contrast, as shown in FIGS. 5(a) and 5(b), and FIGS. 6(a) and 6(b), it is confirmed that the magnetic nano-structures according to Examples 3 and 4 exhibit a diffraction pattern formed by mixing the Sm2Co7 phase, the Fe single phase, and the Sm₂Co₁₇ phase. Accordingly, when the magnetic nano-structure includes the mixed phase, there may be the problem of lowering the coercive force.

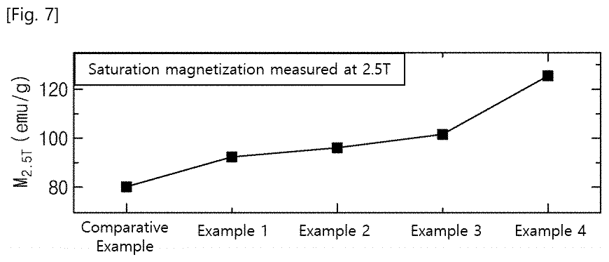

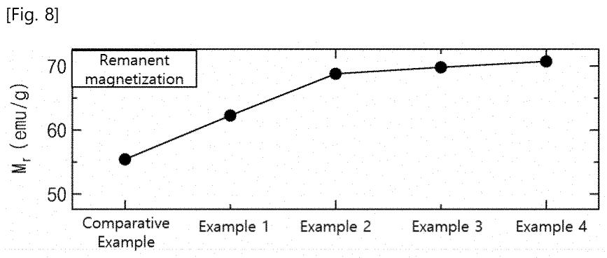

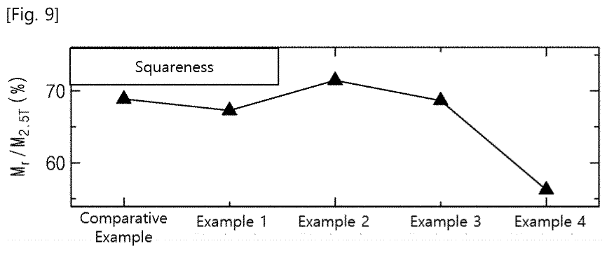

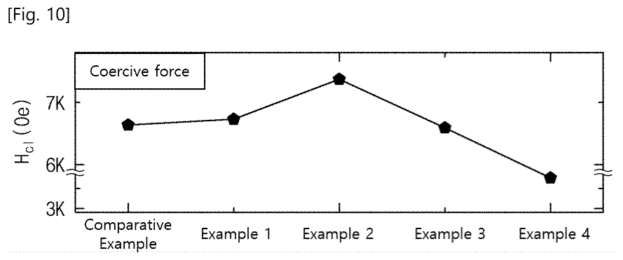

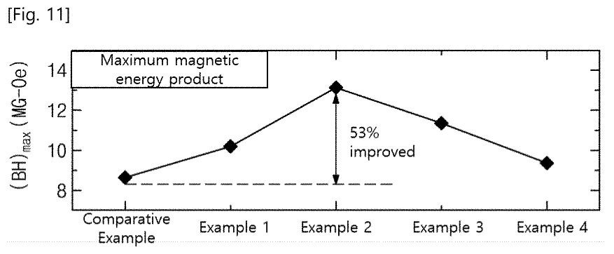

FIG. 7 is a graph for comparing saturation magnetizations of the magnetic nano-structures according to the Examples and Comparative Example of the present invention. FIG. 8 is a graph for comparing remanence magnetizations of the magnetic nano-structures according to the Examples and Comparative Example of the present invention. FIG. 9 is a graph for comparing rectangularity ratios of the magnetic nano-structures according to the Examples and Comparative Example of the present invention. FIG. 10 is a graph for comparing coercive forces of the magnetic nano-structures according to the Examples and Comparative Example of the present invention. FIG. 11 is a graph for comparing maximum magnetic energy products of the magnetic nano-structures according to the Examples and Comparative Example of the present invention.

FIGS. 7 to 11 show the saturation magnetization, remanence magnetization, rectangularity ratio, coercive force, and maximum energy product of the nano-structures according to Examples 1 to 4 and Comparative Example, respectively. Values on magnetic properties measured through FIGS. 7 to 11 will be summarized in the following <Table 3>.

TABLE 3

| | | | | | Maximum |
|---|---|---|---|---|---|
| | | | | | magnetic |
| | Saturation | Remanence | | Coercive | energy |
| | magnetization | magnetization | Rectangularity | force | product |
| Item | (emu/g) | (emu/g) | ratio (%) | (Oe) | (MGOe) |
| Comparative | 80.191 | 55.254 | 68.904 | 6633.1 | 8.61 |
| Example | | | | | |
| Example | 92.284 | 62.122 | 67.316 | 6724.6 | 10.23 |
| 1 | | | | | |
| Example | 96.037 | 68.611 | 71.443 | 7374.5 | 13.17 |
| 2 | | | | | |
| Example | 101.45 | 69.651 | 68.655 | 6591.0 | 11.37 |
| 3 | | | | | |
| Example | 125.43 | 70.712 | 56.376 | 3784.3 | 9.36 |
| 4 | | | | | |

As shown in FIGS. 7 to 11 and <Table 3>, it is confirmed that the saturation magnetizations gradually increase in a sequence of the magnetic nano-structures according to Comparative Example, Example 1, Example 2, Example 3, and Example 4. In other words, it is found that the saturation magnetization also increases as the content of Fe in place of Co increases.

However, it is confirmed that the coercive forces gradually and sequentially increase until the Comparative Example, Example 1, and Example 2, but rather decrease in Example 3 and Example 4. In other words, when the substitution amount of Fe in place of Co is 20% or more, the coercive force decreases. It may be determined that the decrease occurs when the magnetic nano-structure is separated into a plurality of phases, as confirmed in FIGS. 5 and 6.

As a result, it is confirmed that the magnetic nano-structure according to Example 3, in which the substitution amount of Fe is 10% in place of Co, exhibits a high coercive force of 7374.5 Oe, and also has the highest maximum magnetic energy product indicated at 13.17 MGOe. In particular, it can be seen that the magnetic nano-structure indicates a remarkable improvement of about 53% when compared with the maximum magnetic energy product of the magnetic nano-structure according to the Comparative Example that does not contain Fe.

Although the present invention has been described in detail with reference to the preferred embodiments, the present invention is not limited to the specific embodiments and shall be interpreted by the following claims. In addition, it will be apparent that a person having ordinary skill in the art may carry out various deformations and modifications for the embodiments described as above within the scope without departing from the present invention.

### INDUSTRIAL APPLICABILITY

The magnetic nano-structure containing iron (Fe) according to the embodiments of the present invention may be applicable to various industrial fields for permanent magnets, electric motors, sensors, and the like.

1. A method for manufacturing a magnetic nano-structure, the method comprising:
preparing a source solution containing a first precursor including a rare-earth element, a second precursor including a transition metal element, and a third precursor including Fe;
forming a preliminary magnetic nano-structure containing a rare-earth oxide, a transition metal oxide, and Fe oxide by electrospinning the source solution; and
manufacturing a magnetic nano-structure containing an alloy composition of the rare-earth element, the transition metal element, and the Fe by reducing the preliminary magnetic micro-structure.

2. The method of claim 1, wherein Fe in the source solution has a weight ratio more than 3.7 wt % and less than 14.7 wt %.

3. The method of claim 1, wherein the forming of the magnetic nano-structure includes:
mixing the preliminary magnetic nano-structure with a reducing agent;
heat-treating the preliminary magnetic nano-structure mixed with the reducing agent; and
washing the heat-treated preliminary magnetic nano-structure by using a cleaning solution.

4. The method of claim 1, wherein the reducing agent includes calcium (Ca).

5. The method of claim 1, wherein a maximum magnetic energy product value ((BH)ₘₐₓ) is controlled by controlling a content of Fe.

6. A magnetic nano-structure comprising:
an alloy composition of a rare-earth element, a transition metal element, and Fe, wherein
Fe in the alloy composition has a content more than 3.7 wt % and less than 14.7 wt %.

7. The magnetic nano-structure of claim 6, wherein the alloy composition is composed of a unit lattice (unit cell) represented by Re₂M₁₇ (Re is a rare-earth element, M: at least one of a transition metal element or Fe).

8. The magnetic nano-structure of claim 7, wherein a crystal structure of the Re₂M₁₇ is any one of a hexagonal system or a rhombohedral system.

9. The magnetic nano-structure of claim 7, wherein Fe is disposed in at least one of 4f, 6g, 12j, and 12k sites in the unit lattice.

10. The magnetic nano-structure of claim 6, wherein the rare-earth element includes at least one of La, Ce, Pr, Nd, Sm, or Gd.

11. The magnetic nano-structure of claim 6, wherein the transition metal element includes at least one of Co or Ni.

12. The magnetic nano-structure of claim 6, wherein the magnetic nano-structure has a single crystal and an anisotropic property.

13. The magnetic nano-structure of claim 6, wherein, in the alloy composition, the rare-earth element has a content more than 23.1 wt % and less than 23.3 wt %, and the transition metal element has a content more than 62.0 wt % and less than 73.2 wt %.

14. A magnetic nano-structure comprising:
an alloy composition composed of a unit lattice represented by Formula 1.
Re₂TMxFe₁₇₋ₓ <Formula 1>
(Re: rare-earth element, TM: transition metal element)

15. The magnetic nano-structure of claim 14, wherein the magnetic nano-structure comprises:
an alloy composition having a unit lattice represented by <Formula 1> after more than 5% and less than 20% of the TM is substituted with Fe in an alloy composition composed of a unit lattice represented by <Formula 2>.
Re₂TM₁₇ <Formula 2>
(Re: rare-earth element, TM: transition metal element)

16. The magnetic nano-structure of claim 14, wherein the magnetic nano-structure has a coercive force of 7000 Oe or more.
